(19) United States
(12) Patent Application Publication
(10) Pub. No.: US 2005/0030451 A1
(43) Pub. Date: Feb. 10, 2005

(54) Pixel for a fringe field switching reflective and transflective liquid crystal display

(76) Inventor: Hong-Da Liu, Jubei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/890,188

(22) Filed: Jul. 14, 2004

(30) Foreign Application Priority Data
Aug. 6, 2003 (TW) 092121543

(51) Int. Cl. G02F 1/1335

(52) U.S. Cl. 349/113

(57) ABSTRACT

By employing an ultra-micro scattering layer with a top surface in a nano-scale roughness resulted from the crystallization or the property of the material within the ultra-micro scattering layer in a pixel for a fringe field switching liquid crystal display, the mask steps to manufacture the liquid crystal display and the cost therefore are reduced. The nano-scale roughness of the top surface on the ultra-micro scattering layer results in larger scattering angle and smooth distribution for the scattering effect. Accordingly, the reflectivity will not vary violently with the viewing angle, and excellent anti-glare effect is obtained also.

### FIELD OF THE INVENTION

The present invention relates generally to a fringe field switching (FFS) liquid crystal display (LCD) and more particularly, to a pixel for an FFS-LCD with a nano-scale rough surface thereof and without more mask steps to manufacture therefore.

### BACKGROUND OF THE INVENTION

In a conventional FFS-LCD, the electrode is made of ITO and in transmissive manner for the modulated light to pass therethrough, and on the other hand, the typical reflective twisted nematic (RTN) TFT-LCD employs metal to implement the reflector thereof for the light to be reflected thereby. When the reflector for an LCD is made of metal, the reflective surface is so smooth that mirror-like reflection is occurred for the light reflected by that reflector, and thus the viewing angle of the display is limited. To enhance the scattering effect to the light, an organic layer such as resin is introduced under the reflector so as to result in roughness on the reflective surface. However, to introduce the organic layer requires more mask steps, and thus the total mask steps to manufacture an LCD need about 8˜10 masks, whereby increasing the manufacturing cost. Moreover, organic material has bad thermal endurability, which is up to only around 250° C., and the rough surface formed thereof has great height difference in the range of 0.5-1.5 μm, which produces too large optical-path difference Δnd, and thereby lower efficiency of reflecting light from ideally 100% to between 60%˜85%.

Therefore, it is desired an FFS-LCD with a nano-scale rough surface thereof and without more mask steps to manufacture therefore.

### SUMMARY OF THE INVENTION

An object of the present invention is to provide a pixel for an FFS-LCD with a nano-scale rough surface thereof.

Another object of the present invention is to provide a pixel for an FFS-LCD with reduced mask steps to manufacture therefore.

In a pixel for an FFS-LCD, according to the present invention, on a substrate an ultra-micro scattering layer with a top surface in a nano-scale roughness resulted from the crystallization or the property of the material within the ultra-micro scattering layer is formed, and a reflective layer is then formed on the ultra-micro scattering layer to be conformal to the top surface, so as to obtain a reflective surface in a nano-scale roughness thereon. As a result, no additional mask steps are required for the reflective surface to have scattering effect, thereby reducing the manufacturing cost. Moreover, the nano-scale roughness of the reflective surface improves the efficiency of reflecting light because of the reduced optical-path difference And thereof and larger scattering angle and smooth distribution for the scattering effect. Accordingly, the reflectivity of the LCD will not vary violently with the viewing angle, and excellent anti-glare effect is obtained additionally.

### BRIEF DESCRIPTION OF DRAWINGS

These and other objects, features and advantages of the present invention will become apparent to those skilled in the art upon consideration of the following description of the preferred embodiments of the present invention taken in conjunction with the accompanying drawings, in which:

FIG. 1 shows a schematic diagram of the cross-sectional view of a pixel for a reflective LCD according to the present invention;

FIG. 2 shows a schematic diagram of the top view of an embodiment electrode for the pixel shown in FIG. 1;

FIG. 3 shows a schematic diagram of the top view of another embodiment electrode for the pixel shown in FIG. 1;

FIG. 4 shows a schematic diagram of the cross-sectional view of first embodiment pixel for a transflective LCD according to the present invention;

FIG. 5 shows a schematic diagram of the cross-sectional view of second embodiment pixel for a transflective LCD according to the present invention;

FIG. 6 shows a schematic diagram of the cross-sectional view of third embodiment pixel for a transflective LCD according to the present invention; and

FIG. 7 shows a schematic diagram of the cross-sectional view of a thin-film transistor implemented with CMOS for an LCD.

### DETAILED DESCRIPTION OF THE INVENTION

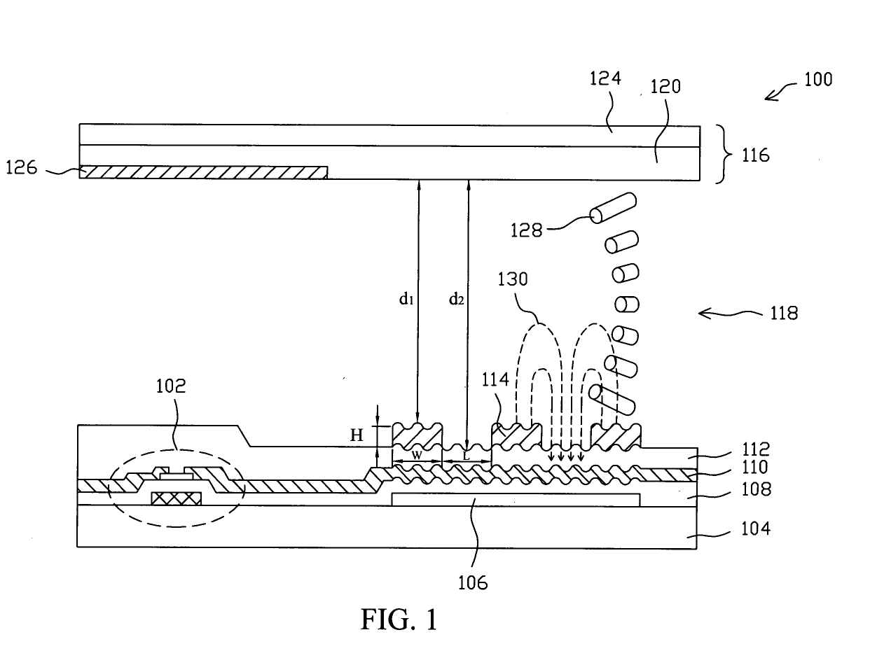

FIG. 1 shows a schematic diagram of the cross-sectional view of a pixel 100 for a reflective LCD according to the present invention, in which a thin-film transistor 102 is formed on a substrate 104, an ultra-micro scattering layer including a transparent conductive layer 106 and an insulator layer 108 is also formed on the substrate 104. The transparent conductive layer 106 can be formed of ITO or IZO, and the insulator layer 108 is covered over the transparent conductive layer 106. A metal layer 110 is covered over the insulator layer 108, which is formed with the same metal layer of manufacturing the source/drain of the thin-film transistor 102, and has a high reflectivity. A passivation layer 112 is further covered over the thin-film transistor 102 and the metal layer 110. A reflective layer is formed with several high reflective metal stripes 114 on the passivation layer 112, and each of the metal stripes 114 can be bent. An optical stack 116 is spaced from the reflective layer 114, and a layer of liquid crystal 116 with a horizontal rubbing direction between the reflective layer 114 and the optical stack 116. The optical stack 116 includes a color filter 120 and a polarizer 124 on the color filter 120, and a black matrix 126 formed of black resin is arranged at the front end of the color filter 120, which structure has no ITO thereof. The insulator layer 108 is made of for example silicon nitride, silicon oxide, and silicon oxide nitride.

The insulator layer 108 of the pixel 100 shown in FIG. 1 is formed by physical or chemical vapor depositions. When the insulator layer 108 is formed on the transparent conductive layer 106, due to the property of the material to form the insulator layer 108, its top surface will become of a nano-scale roughness simultaneously, by which the metal layer 110 formed afterwards on the insulator layer 108 will obtain a top surface in a nano-scale roughness because of its being conformal to the nano-scale rough surface of the insulator layer 108. Likewise, the passivation layer 112 is conformal to the nano-scale rough surface of the metal layer 110 when it is deposited and thus has a top surface in a nano-scale roughness. The metal stripes 114 are also conformal to the nano-scale rough surface of the passivation layer 112, so as to have top surface in a nano-scale roughness to enhance scattering effect without introducing additional mask steps. Obviously, the manufacturing cost for the LCD is reduced eventually.

The variation of the top surface in a nano-scale roughness within the LCD according to the present invention is ranged from 1 to 500 nm, and whose variation pitch is between 10 to 1500 nm, much smaller than that of conventional reflector typically of 5 to 20 μm. As a result, the scattering angle becomes wider and more uniform, and the variation of the optical-path difference And is ranged between 0.1 and 0.5 μm, which further improves the efficiency of reflecting light. Alternatively, the ultra-micro scattering layer can be obtained by the formation of a seed layer in combination with the insulator layer 108 with crystallization process.

As shown in FIG. 1, the metal strips 114 have a gap L between each two of them, and each of the metal stripes 114 has width W and thickness H. The gap L and width W each ranges from 0.3 to 15 μm, and the thickness H is between 0.01 to 2 μm. The designated d1 and d2 are the average cell gaps from the optical stack 116 to the reflective layer 114 and the passivation layer 112, respectively, where d2 ranges from 3 to 4.8 μm, and the ratio of d1 to d2 is about 0.45 to 1. The passivation layer 112 includes for example silicon nitride, silicon oxide, or silicon oxide nitride, and whose thickness is about 0.15 to 3 μm. The metal layer 110 can be made of silver, aluminum or any alloy of high reflectivity. The metal layer 110 can also be of partially transmissive metal. Since the passivation layer 112 is sandwiched between the metal stripes 114 and the metal layer 110, a storage capacitor is obtained, and no extra design for storage capacitor is required, thereby keeping the aspect ratio of the pixel 100 at high.

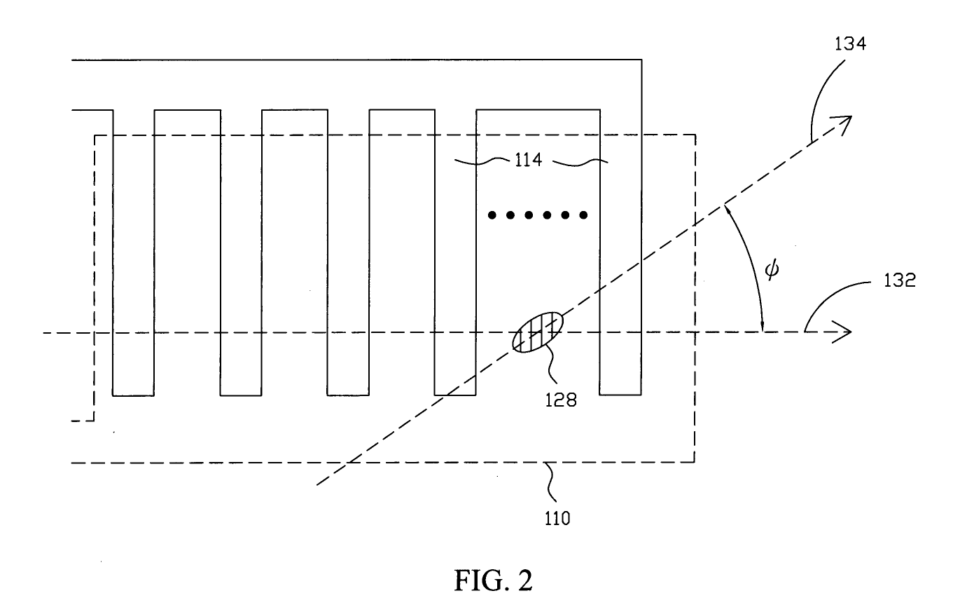

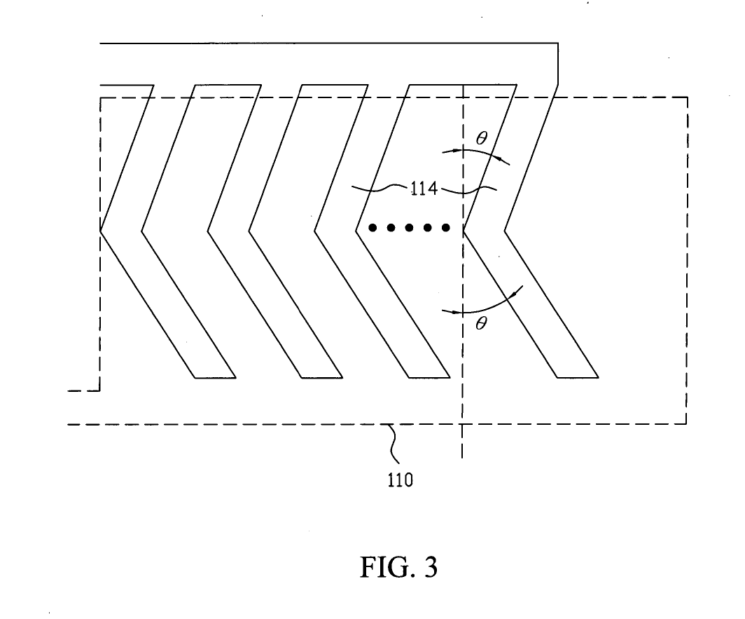

Referring to FIG. 1, when a voltage is applied to the pixel 100, a fringe field 130 is generated between the metal layer 110 and the metal strips 114 to twist the liquid crystal molecules 128 in the layer 118. FIG. 2 shows a schematic diagram of the top view of an embodiment electrode for the pixel shown in FIG. 1. The direction of the metal strips 114 has an angle φ with the rubbing direction 134 of the liquid crystal molecules 128. If negative liquid crystal is employed for the layer 118, the angle φ is preferably ranged from 3 to 30 degrees. Contrarily, if positive liquid crystal is employed for the layer 118, the angle φ is preferably ranged between 60 and 85 degrees. The metal stripes 114 can be bent, as shown in FIG. 3., with a tilting angle of 3 to 30 degrees.

Negative liquid crystal is preferred for the layer 118 within the pixel 100, with dielectric constant Δε of −2.5 to −7 and birefringence Δn of 0.027 to 0.11.

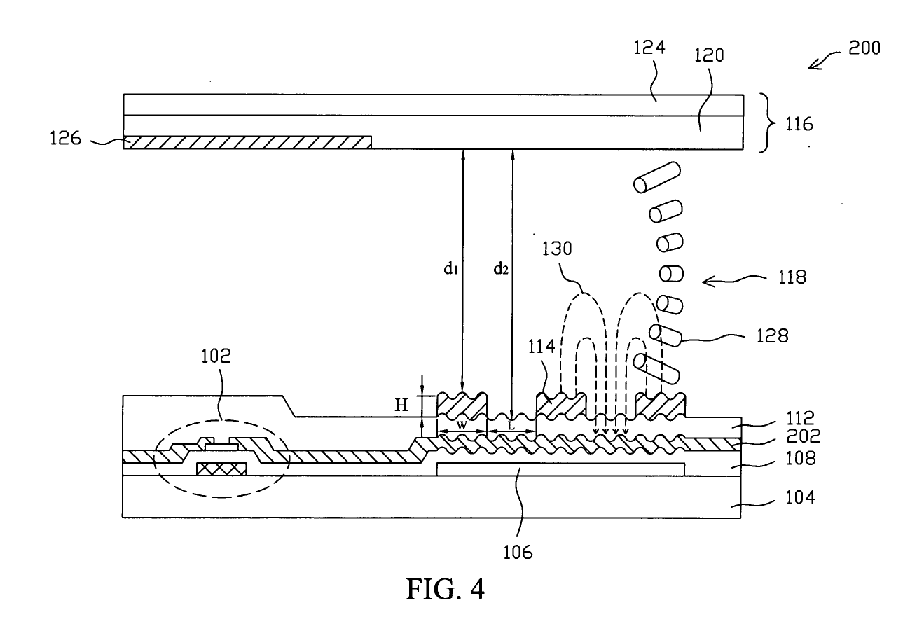

FIG. 4 shows a schematic diagram of the cross-sectional view of first embodiment pixel 200 for a transflective LCD according to the present invention, which is similar to the pixel 100 shown in FIG. 1, and comprises a thin-film transistor 102 on a substrate 104, a transparent conductive layer 106 with an insulator layer 108 and a passivation layer 112 thereon, a reflective layer including several metal stripes 114, and a layer 118 of liquid crystal molecules 128 with a horizontal rubbing direction sandwiched between the reflective layer 114 and an optical stack 116 including a color filter 120 and a polarizer 124. However, the pixel 200 employs a transparent conductive layer 202 to replace the metal layer 110 of the pixel 100 shown in FIG. 1. Likewise, when the insulator layer 108 is formed on the transparent conductive layer 106, due to the property of the material to form the insulator layer 108, its top surface will become of a nano-scale roughness simultaneously, and by which the transparent conductive layer 202 formed on the insulator layer 108 will obtain a top surface in a nano-scale roughness because of its being conformal to the nano-scale rough surface of the insulator layer 108. Since the passivation layer 112 is conformal to the nano-scale rough surface of the transparent conductive layer 202 when it is deposited, it thus has a top surface in a nano-scale roughness. The metal stripes 114 are also conformal to the nano-scale rough surface of the passivation layer 112, so as to have top surface in a nano-scale roughness to enhance scattering effect without introducing additional mask steps.

Likewise, the variation of the top surface in a nano-scale roughness within the LCD in this embodiment is ranged from 1 to 500 nm, and whose variation pitch is between 10 to 1500 nm. The variation of the optical-path difference Δnd is ranged between 0.1 and 0.5 μm. The metal strips 114 have a gap L between each two of them and width W ranged from 0.3 to 15 μm, and the thickness H of them is between 0.01 to 2 μm. The passivation layer 112 has a thickness of about 0.15 to 3 μm, and the average cell gap d2 is in the range of 3 to 4.8 μm. The cell gap ratio of d1 to d2 is between 0.45 and 1. When a voltage is applied to the pixel 200, a fringe field 130 is generated between the transparent conductive layer 202 and the metal stripes 114 to twist the liquid crystal molecules 128 in the layer 118. The liquid crystal molecules 128 can be positive type or negative type, whereas the latter is preferred.

Likewise, due to the passivation layer 112 sandwiched between the metal strips 114 and the transparent conductive layer 202, a storage capacitor is obtained, and thus no more design on the storage capacitor is required, thereby keeping the aspect ratio of the pixel 200 at high.

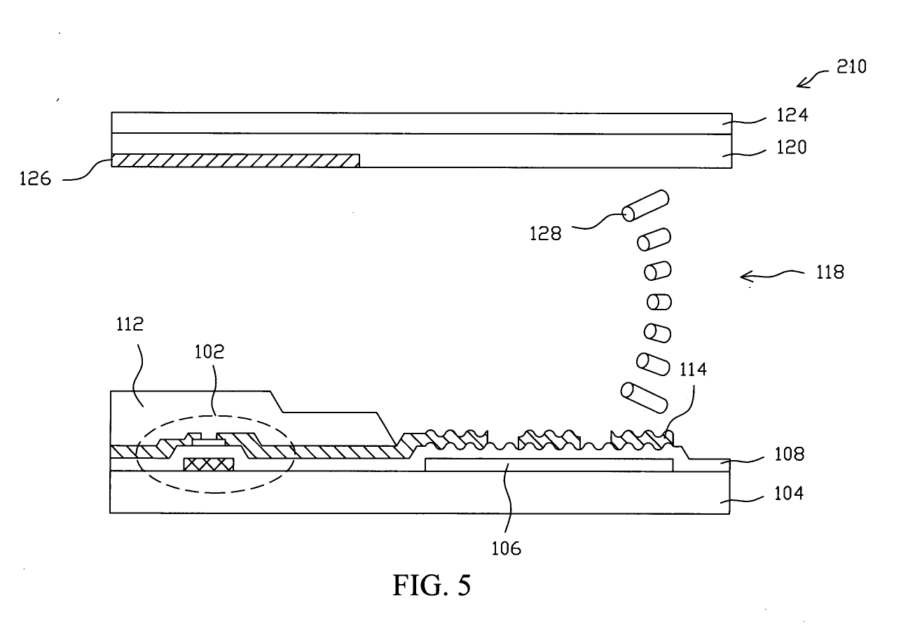

FIG. 5 shows a schematic diagram of the cross-sectional view of second embodiment pixel 210 for a transflective LCD according to the present invention, which comprises a thin-film transistor 102 on a substrate 104, an ultra-micro scattering layer including a transparent conductive layer 106 and an insulator layer 108, a passivation layer 112, a reflective layer including several metal stripes 114, a layer 118 of liquid crystal molecules 128 with a horizontal rubbing direction sandwiched between the reflective layer 114 and an optical stack 116 including a color filter 120 and a polarizer 124, and a black matrix 126 at the front end of the color filter 120 to shield the thin-film transistor 102. In the pixel 210, the thin-film transistor 102 and the ultra-micro scattering layer are arranged on the substrate 104, and the reflective layer 114 is formed on the ultra-micro scattering layer and is formed of the same metal layer to implement the source/drain of the thin-film transistor 102. The passivation layer 112 is covered over the thin-film transistor 102. As in the foregoing embodiments, the insulator layer 108 obtains a top surface in a nano-scale roughness when it is deposited on the transparent conductive layer 106 due to the property of the material to form the insulator layer 108, and the metal strips 114 is conformal to the insulator layer 108, so that the metal stripes 114 have a top surface in a nano-scale roughness to enhance scattering effect without introducing additional mask steps.

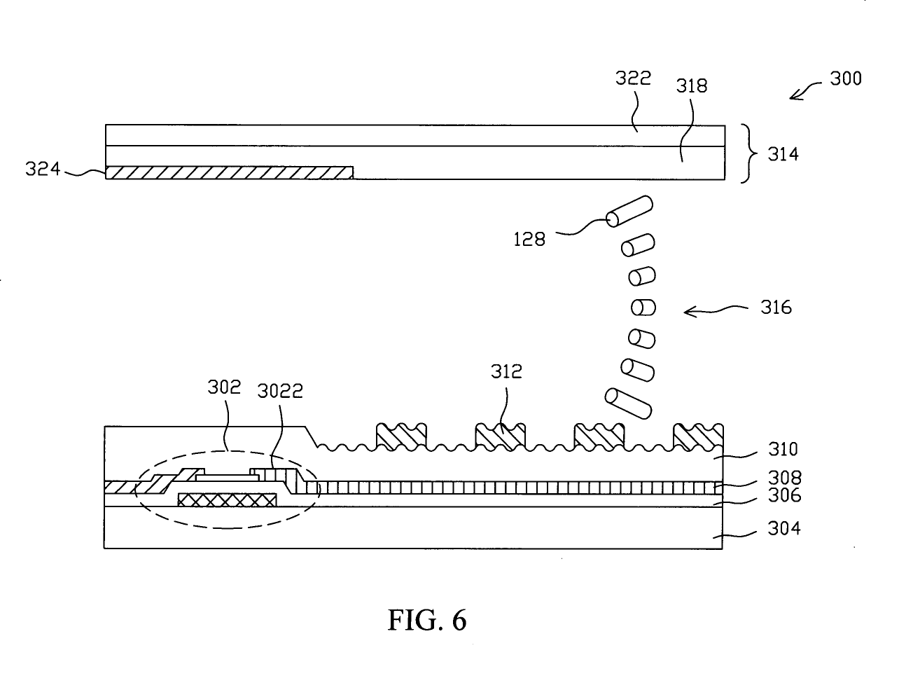

FIG. 6 shows a schematic diagram of the cross-sectional view of third embodiment pixel 300 for a transflective LCD according to the present invention, which comprises a thin-film transistor 302 on a substrate 304, an insulator layer 306 on the substrate 304, an ultra-micro scattering layer including a transparent conductive layer 308 and an insulator layer 310 with the transparent conductive layer 308 sandwiched between the two insulator layers 306 and 310 and formed of the same metal layer to manufacture the drain 3022 of the thin-film transistor 302, a reflective layer 312 including several high reflective metal stripes on the insulator layer 310, an optical stack 314, and a layer 316 of liquid crystal molecules 128 arranged between the optical stack 314 and the reflective layer 312. The optical stack 314 includes a color filter 318 and a polarizer 322, and a black matrix 324 is disposed at the front end of the color filter 318. The insulator layer 310 is made of for example silicon nitride or silicon oxide.

Likewise, the insulator layer 310 can be formed by physical or chemical vapor depositions. When the insulator layer 310 is deposited on the transparent conductive layer 308, its top surface will become of a nano-scale roughness due to the property of the material to form the insulator layer 310. The metal strips 312 are conformal to the nano-scale rough surface of the insulator layer 310, it is thus required no extra mask steps for the metal stripes 312 to have a top surface in a nano-scale roughness.

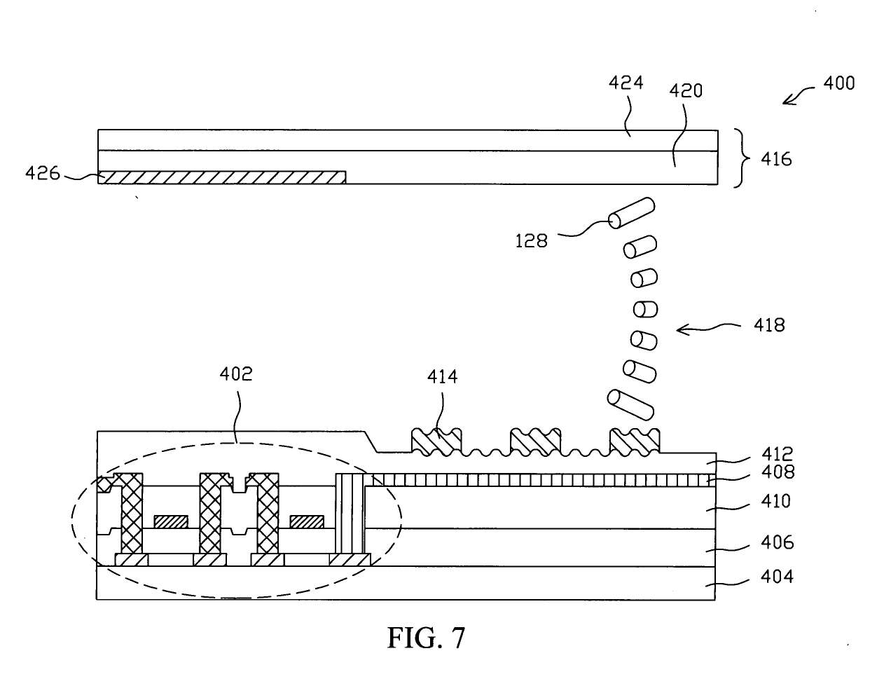

The thin-film transistors in the foregoing embodiments can be replaced with CMOS transistor, as shown in FIG. 7, illustrated by a pixel 400 manufactured by a low-temperature poly-silicon (LTPS), which comprises a CMOS thin-film transistor 402 on a substrate 404, an insulator layer 406 on the substrate 404, a transparent conductive layer 408 sandwiched between passivation layers 410 and 412 with the transparent conductive layer 408 made of ITO and the passivation layer 412 to implement an ultra-micro scattering layer, a reflective layer 414 including several metal stripes made of high reflective metal on the passivation layer 412, an optical stack 416, and a layer 418 of molecules 128 with a horizontal rubbing direction arranged between the optical stack 416 and the reflective layer 414. The optical stack 416 includes a color filter 420, a black matrix 426 and a polarizer 424.

The pixel for a reflective or transflective LCD according to the present invention can be applied to TFT-LCD, LTPS LCD, thin-film diode (TFD) LCD, and liquid crystal on silicon (LCoS) display.

While the present invention has been described in conjunction with preferred embodiments thereof, it is evident that many alternatives, modifications and variations will be apparent to those skilled in the art. Accordingly, it is intended to embrace all such alternatives, modifications and variations that fall within the spirit and scope thereof as set forth in the appended claims.

1. A pixel of a fringe field switching reflective liquid crystal display, comprising:
an ultra-micro scattering layer on a substrate, having a first top surface in a nano-scale roughness resulted from a property of a material within the ultra-micro scattering layer;
a metal layer on the ultra-micro scattering layer, conformal to the first top surface to thereby form a second top surface substantially in the nano-scale roughness;
a reflective layer on the metal layer, conformal to the second top surface to thereby form a reflective surface substantially in the nano-scale roughness;
an optical stack above the reflective surface; and
a layer of liquid crystal with a horizontal rubbing direction, arranged between the reflective surface and the optical stack.

2. The pixel of claim 1, wherein optical stack comprises:
a color filter; and
a polarizer on the color filter.

3. The pixel of claim 1, wherein the nano-scale roughness whose variation of the top surface is ranged from 1 to 500 nm.

4. The pixel of claim 1, wherein the nano-scale roughness whose variation pitch is between 10 to 1500 nm.

5. The pixel of claim 1, wherein the ultra-micro scattering layer comprises:
a transparent conductive layer on the substrate; and
an insulator layer on the transparent conductive layer, having the first top surface thereon.

6. The pixel of claim 1, wherein the insulator layer comprises silicon nitride, silicon oxide, and silicon oxide nitride.

7. The pixel of claim 1, wherein the transparent conductive layer is ITO or IZO.

8. The pixel of claim 1, wherein the ultra-micro scattering layer comprises at least one insulator layer having the first top surface thereon.

9. The pixel of claim 1, wherein the ultra-micro scattering layer comprises a seed layer and an insulator layer having the first top surface thereon.

10. The pixel of claim 9, wherein the insulator layer is formed with crystallization process.

11. The pixel of claim 1, wherein the reflective layer comprises a plurality of metal stripes.

12. The pixel of claim 11, wherein the metal stripes each has width ranges from 0.3 to 15 μm.

13. The pixel of claim 11, wherein the metal stripes have a gap between each two of them, and the gap ranges from 0.3 to 15 μm.

14. The pixel of claim 11, wherein the plurality of metal stripes each is bent with a tilting angle of 3 to 30 degrees.

15. The pixel of claim 1, wherein the liquid crystal layer with variation of the optical-path difference is ranged between 0.1 and 0.5 μm.

16. The pixel of claim 1, wherein the liquid crystal layer is negative liquid crystal.

17. The pixel of claim 16, wherein the liquid crystal molecules has the rubbing direction angle between 3 to 30 degrees.

18. The pixel of claim 1, wherein the liquid crystal layer is positive liquid crystal.

19. The pixel of claim 18, wherein the liquid crystal molecules has the rubbing direction angle between 60 to 85 degrees.

20. The pixel of claim 1, further comprising a thin-film transistor on the substrate, whose source/drain are made of the metal layer.

21. The pixel of claim 1, wherein a first and second cell gaps are formed between the optical stack and the reflective layer and the passivation layer, respectively. The ratio of first cell gap to second cell gap is about 0.45 to 1.

22. The pixel of claim 1, wherein a first and second cell gaps are formed between the optical stack and the reflective layer and the passivation layer, respectively. The second cell gap ranges from 3 to 4.8 μm.

23. A pixel of a fringe field switching transflective liquid crystal display, comprising:
an ultra-micro scattering layer on a substrate, having a first top surface in a nano-scale roughness resulted from a property of a material within the ultra-micro scattering layer;
a partially reflective layer on the ultra-micro scattering layer, conformal to the first top surface to thereby form a second top surface substantially in the nano-scale roughness;
an optical stack above the second top surface; and
a layer of liquid crystal with a horizontal rubbing direction, arranged between the partially reflective layer and the optical stack.

24. The pixel of claim 23, further comprising a transparent conductive layer between the ultra-micro scattering layer and the partially reflective layer, conformal to the first top surface to thereby form a third top surface substantially in the nano-scale roughness.

25. The pixel of claim 24, further comprising a thin-film transistor on the substrate, whose source/drain are made of the transparent conductive layer.

26. The pixel of claim 23, further comprising a thin-film transistor on the substrate, whose source/drain are made of the partially reflective layer.

27. The pixel of claim 24, further comprising a passivation layer between the partially reflective layer and the transparent conductive layer.

28. The pixel of claim 23, wherein the nano-scale roughness whose variation of the top surface is ranged from 1 to 500 nm.

29. The pixel of claim 23, wherein the nano-scale roughness whose variation pitch is between 10 to 1500 nm.

30. The pixel of claim 23, wherein the ultra-micro scattering layer comprises:
a transparent conductive layer on the substrate; and
an insulator layer on the transparent conductive layer, having the first top surface thereon.

31. The pixel of claim 30, wherein the transparent conductive layer is ITO or IZO.

32. The pixel of claim 30, further comprising a thin-film transistor on the substrate, whose source/drain are made of the transparent conductive layer.

33. The pixel of claim 23, wherein the ultra-micro scattering layer comprises at least one insulator layer having the first top surface thereon.

34. The pixel of claim 23, wherein the ultra-micro scattering layer comprises a seed layer and an insulator layer having the first top surface thereon.

35. The pixel of claim 34, wherein the insulator layer is formed with crystallization process.

36. The pixel of claim 23, wherein the partially reflective layer comprises a plurality of metal stripes.

37. The pixel of claim 36, wherein the metal stripes each has width ranges from 0.3 to 15 μm.

38. The pixel of claim 36, wherein the metal stripes have a gap between each two of them, and the gap ranges from 0.3 to 15 μm.

39. The pixel of claim 36, wherein the plurality of metal stripes each is bent with a tilting angle of 3 to 30 degrees.

40. The pixel of claim 23, wherein the liquid crystal layer with variation of the optical-path difference is ranged between 0.1 and 0.5 μm.

41. The pixel of claim 23, wherein the liquid crystal layer is negative liquid crystal.

42. The pixel of claim 41, wherein the liquid crystal molecules has the rubbing direction angle between 3 to 30 degrees.

43. The pixel of claim 23, wherein the liquid crystal layer is positive liquid crystal.

44. The pixel of claim 43, wherein the liquid crystal molecules has the rubbing direction angle between 60 to 85 degrees.

45. The pixel of claim 23, wherein the partially reflective layer comprises:
a reflective region with a first cell gap between the reflective region and the optical stack; and
a transmissive region with a second cell gap between the transmissive region and the optical stack.

46. The pixel of claim 45, wherein the ratio of first cell gap to second cell gap is about 0.45 to 1.

47. The pixel of claim 45, wherein the second cell gap ranges from 3 to 4.8 μm.

48. The pixel of claim 23, wherein optical stack comprises:
a color filter;
a black matrix at the front end of the color filter comprises black resin; and
a polarizer on the color filter.
